(19) United States
(12) Patent Application Publication
(10) Pub. No.: US 2008/0281561 A1
(43) Pub. Date: Nov. 13, 2008

(54) Internet Enabled Consultation System, Method and Service for Interior Design of Real and Virtual Spaces

(75) Inventors: Joshua Shulman, Tel Aviv (IL); Daniel Cesar-Vieira, Tokyo (JP)

Correspondence Address: Lilling & Lilling PLLC, PO Box 435, Jerusalem, 91003, IL

(73) Assignee: VIRTUECODE LTD, Kowloon (HK)

(21) Appl. No.: 11/746,212

(22) Filed: May 9, 2007

(51) Int. Cl. G06F 17/50

(52) U.S. Cl. 703/1; 715/719; 715/760

(57) ABSTRACT

The present invention is directed to provide a system for providing design consultancy for a client. This system includes at least one database containing at least one set of design criteria; at least one input interface for receiving data pertaining to: the plan of the space for which design consultancy is required; the furnishing needs for said space; and the design preferences of the client; a data processing unit for selecting at least one set of design criteria in accordance with the design preferences of the client and calculating positions of furniture within said space based upon said design criteria, and at least one output interface for displaying design advice according to said positions calculated for said furniture.

Preferably, at least one set of said design criteria comprises Feng Shui design criteria.

### FIELD OF THE INVENTION

The present invention is directed to space utilization and particularly but not exclusively to interior design.

### BACKGROUND

Homes and offices have limited space. Space usage is complex in that efficient usage of space may give a sense of clutter or claustrophobia which can cause feelings of stress.

Poor interior design, whether concerning ventilation, illumination, dust, the build up of static electricity, wall coloring, floor coloring and texture may result in a general feeling of being unwell known as sick building syndrome (SBS). Sick building syndrome is a combination of ailments and is typically associated with an individual's place of work but there have also been instances of SBS in residential buildings.

A 1984 World Health Organisation report into the syndrome suggested that up to 30% of new and remodelled buildings worldwide cause symptoms of SBS, which is often linked to flaws in heating, ventilation, and air conditioning systems, and may sometimes be ‘cured’ by boosting the overall exchange rate between the air within the building and the outside air. SBS has also been attributed to contaminants produced by out-gassing of some types of building materials, or improper exhaust ventilation of light industrial chemicals used within.

Building occupants with SBS typically complain of symptoms such as: headache, eye, nose, or throat irritation, dry coughs, dry or itchy skin, dizziness and nausea, difficulty in concentrating, fatigue, sensitivity to odours and the like. It is a feature of the syndrome that the symptoms disappear soon after the occupants go outside. SBS may cause high levels of employee sickness, absenteeism, lower productivity, low job satisfaction and high employee turnover.

Lighting affects moods and ambience. Correct lighting is required for plants to thrive, and it appears that the choice of lighting and its intensity affects the wellbeing of occupants. Exposure to natural light and ventilation with fresh air are critical.

Feng Shui, meaning “wind and water”, is an ancient Chinese practice of placement and arrangement of space to achieve harmony with the environment. Deriving from Chi His's writings in the twelve and thirteenth centuries, the system uses geographical, philosophical, aesthetic, psychological and astrological concepts in relation to space and energy (Qi) flow. It is more than simply a decorating style, being a discipline having guidelines that are compatible with a wide range of architectural planning techniques.

The “wind aspect” carries Qi energy and represents the principle of change. When applied to humans, the wind aspect represents fervor, intensity, enthusiasm and charisma. The “water aspect” holds energy and represents the principle of stability, inner strength and meditative power.

Application of Feng Shui techniques to physical space is believed by its adherents to be able to affect the human condition of those living or working within the space. In particular, the luck, health and prosperity of humans is affected by the characteristics of the space in which they live. Since Feng Shui is based on energy, it is also believed that the inhabitants have an effect on their surroundings.

Essentially Feng Shui is related to the dichotomy of Yin Yang. The goal of Feng Shui is to locate and orient dwellings, possessions and landscapes to be attuned to the flow of qi. Location is the main aspect. The bagua is an octagonal diagram comprising eight trigrams or guas. The eight trigrams are: Heaven, Earth, Fire, Water, Thunder, Lake, Mountain and Wind. Heaven is the Creative principle which contains the potential for all manifestation. Earth is the Receptive principle which contains the potential for physical manifestation. Fire is the Clinging principle which contains the potential for achievement, clarity, and vitality. Water is the Abysmal principle which contains the potential for adaptability, mystery, and danger. Thunder is the Arousing principle which contains the initial impulse for all new things. Lake is the Joyous principle which embodies rewards and endings. Mountain is the Stillness principle which contains the potential for serenity and internal power. Wind is the Penetrating principle which contains the power to achieve without effort.

Interior design and living with Feng Shui is complicated and requires expert guidance. For example, the entrance door to an office or similar room should be in clear view from the desk. The stove should not be placed in the north part of the home since water extinguishes fire. There are other considerations however, that may override this principle. The end of the bed should not face the door. (This principle is also recorded in Jewish custom and attributed to the fact that the dead are carried out feet first). Straight lines and corners are to be avoided—especially pointing to the bed. Clutter should be avoided. Table tops should be kept simple and clutter free. Stairs should never face the front door. Mirrors, windchimes, pools of water, flowing water and crystals can redirect or shift energy.

Feng Shui has several distinct schools of thought. The Form School developed into the Compass School and the Black Hat School. The Compass School is based on the study of the 28 constellations along the solar ecliptic and is utilized by both the East-West Group and the Time and Space Method.

The Black Sect is a western development of Feng Shui that is self-contained in that it orients the bagua with the entrance to a space, rather than Northwards. There is also a Flying Star school. Classical Feng Shui is practiced in both Asia and in the West, is an amalgam of the above traditional aspects.

Independent Feng Shui consultants charge high fees and skeptics have noted a lack of consistency between the advice of different experts. Its rejecters do not consider that crystals, wind-chimes and table fountains can really impact one's health, finances or relationships. Nevertheless, newspaper articles claim that Prince Charles, Coca Cola, Ford Motors and Proctor & Gamble use Feng Shui.

There are other philosophies, trends and design criteria that are studied by interior designers and architects and used by consultants. With all interior design consulting, there is a cost involved in the fact that the practitioner devotes time to each project. Particularly where travel is involved, the time factor adversely impacts the efficiency of the service and boosts prices. Regardless of the specific design philosophy, the competence of the practitioner and his or her hourly consultancy rates, the time factor is a critical component that affects the cost of the service.

There is a need to make interior design consulting more time effective, and the present invention addresses this need.

### SUMMARY OF THE INVENTION

In a first aspect, the present invention is directed to provide a system for providing design consultancy for a client, said system comprising: at least one database containing at least one set of design criteria;

at least one input interface for receiving data pertaining to:

i. the plan of the space for which design consultancy is required;

ii. the furnishing needs for said space; and

iii. the design preferences of the client;

a data processing unit for selecting at least one set of design criteria in accordance with the design preferences of the client and calculating positions of furniture within said space based upon said design criteria, and

at least one output interface for displaying design advice according to said positions calculated for said furniture.

Preferably, at least one set of said design criteria comprises Feng Shui design criteria.

Typically, at least one set of said design criteria are associated with at least one school of architecture.

Optionally, wherein said input interface comprises a form having at least one field selected from the list of:

a field for uploading a preprepared floor plan of a space;

a field for preparing a plan of the space using CAD technology;

a field for identifying orientation of the space with regards to compass points;

a field for uploading a set of furnishing needs for said space;

a field for selecting a set of furnishing needs from a preprepared list;

a field for selecting at least one set of design criteria stored in the database to be used by the data processing unit; and

a field for uploading a set of design criteria to be used by the data processing unit.

In one embodiment the form comprises an internet enabled web form remotely accessible via a website and displayable by an internet browser.

In a second embodiment, the form is part of a Graphical User Interface of stand alone software for displaying on a monitor of a computer system running the stand alone software.

Optionally, the output interface includes a manual override comprising at least one of:

an editing field for altering the configuration of furniture within the space as calculated by the data processing unit; and

an authorization field for authorizing design advice to be provided for a client.

Typically, the output interface comprises at least one of a list comprising a downloadable file, webpage and Graphical User Interface of stand alone software.

In a second aspect, the invention is directed to providing a method of providing design consultancy for a client comprising the steps of:
(a) saving at least one design criterion in a database;
(b) providing at least one input interface for receiving data from a user;
(c) obtaining data pertaining to a plan of a space or layout for which design consultancy is required;
(d) obtaining data pertaining to furnishing needs for said space;
(e) obtaining data pertaining to design preferences of the client;
(f) using said data processing unit to calculate suggested positions of furniture within said space based upon said design criteria and in accordance with the design preferences of the client; and
(g) providing design advice based upon the suggested positions.

Typically said at least one design criterion comprises a Feng Shui design criterion.

Optionally the at least one design criterion comprises an association with at least one school of architecture.

Optionally said space is a virtual space.

In some embodiments the method further comprises using CAD technology to prepare a three dimensional (virtual) model of the space.

Optionally the method further comprises providing at least one internet web form comprising fields for at least some of the following actions:

uploading a preprepared floor plan of the space;

preparing a plan of the space using CAD technology;

identifying orientation of the space with regards to compass points;

uploading a set of furnishing needs for the space;

selecting a set of furnishing needs from a preprepared list;

selecting at least one set of design criteria stored in the database to be used to calculate positions of furniture within the space, and

uploading a set of design criteria to be used to calculate positions of furniture within the space.

In one embodiment, the method is facilitated by stand alone software and further comprises providing a Graphical User Interface of the stand alone software for at least one of: uploading a preprepared floor plan of the space; preparing a plan of the space using CAD technology; identifying orientation of the space with regards to compass points; uploading a set of furnishing needs for the space; selecting a set of furnishing needs from a preprepared list; selecting at least one set of design criteria stored in the database to be used to calculate positions of furniture within said space; and uploading a set of design criteria to be used to calculate positions of furniture within said space.

Preferably, the method includes the step of providing a manual override for: altering the calculated configuration of furniture within the space; and authorizing design advice to be provided for a client.

The term furniture as used herein includes any movable objects provided within a space, and includes practical pieces of furniture such as chairs and tables, furnishings such as curtains internal non-load bearing walls and ornamental pieces such as vases, plants, sculptures, pictures and the like.

The term CAD as used herein implies any computer aided design package and does not imply a specific software package.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding thereof; the description taken with the drawings making apparent to those skilled in the art how the several forms of the invention may be embodied in practice. In the accompanying drawings:

FIG. 1 is a schematic of the system of the invention in which a remote designer sitting at a computer can receive a floor plan of a space and give design advice;

FIG. 2 shows a possible form to be used in an input interface; and

FIG. 3 is a flowchart describing the general method of the invention.

### DESCRIPTION OF THE PREFERRED EMBODIMENTS

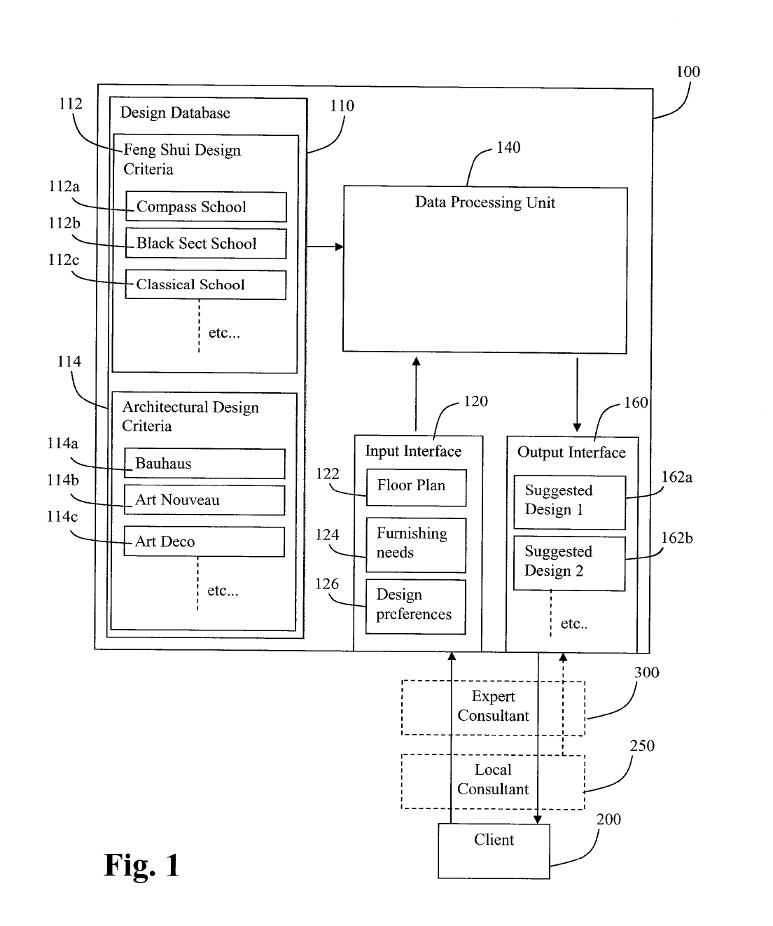

With reference to FIG. 1, an overview of the invention is shown. A system 100 for providing design consultancy for a customer 200 includes a design database 110 containing a plurality of sets of design criteria. The database 110 contains design criteria 112 based upon the principles of Feng Shui according to various schools such as the Compass School criteria 112a, Black Sect School criteria 112b, and Classical Feng Shui criteria 112c. It is noted that criteria of other schools of Feng Shui, such as the Flying Star School and Form School for example, though not shown in FIG. 1, may additionally or alternatively be featured in certain embodiments of the database 110. The database 110 may also contain other design criteria 114 relating to various styles of architecture such as Bauhaus 114a, Art Nouveau 114b, Art Deco 114c for example. Further architectural styles such as Avante Garde, Traditional UK, New World, Modern, Post Modern and Classical, for example, may also be included.

The system 100 is able to interface with a customer 200, and includes one or more input interfaces 120 for receiving raw data from the customer 200 and an output interface 160 for displaying advice and suggestions to the customer 200 pertaining to the layout of the space for which design consultancy is required 122, the furnishing needs 124 and the design preferences 126 of the specific customer 200. In preferred embodiments, the system 100 is web enabled and the input and output interfaces 120, 160 are display fields on the website that are operatively coupled to input/output equipment of the customer's 200 system such as keyboard, mouse, monitor screen, printer, etc. The data received by the input interface 120 of the system 100 is passed to a data processing unit 140 which selects the design criteria from the database 110 in accordance with the design preferences 126 of the customer 200. The data may be provided as a floor-plan, as free text and/or in response to specific questions, such as from a multiple choice type questionnaire, for example. The data processing unit 140 may use appropriate design criteria to calculate the optimal position(s) of furniture within the space. The calculated positions of furniture may be used to display suggested designs 162 and to provide advice to the customer 200, such as on the monitor of the customer's 200 system, according to the positions calculated by the data processing unit 140. The system 100 thereby advises the client regarding the locations of light fittings, furniture and the like, in accordance with the design and layout of the space, such as, inter alia, the size, shape, window positions, orientation and intended use thereof.

Although the system 100 may be highly automated, and will be capable of automatically generating at least one appropriate interior design, and preferably a range of interior design options, it is a feature of preferred embodiments of the invention that a human interior design consultant 300, or team of consultants, reviews the raw data concerning the space and the interior design suggestions, and is able to approve, reject or amend the suggestions of the system; it being appreciated that the customer 200 is interested in a design consultancy with an expert and not in receiving automated responses to real world problems.

It will be appreciated that a local consultant 250 such as retail-point sales support staff at a store selling interior design accessories, paints, light fittings and the like, may mediate between the customer 200 and the system 100. The local consultant 250 may input data into the input interface 120 on behalf of the customer 200 and may modify the design suggestions 162 provided by the output interface 160 following the input of the expert human design consultant 300, before giving design advice to the customer 200.

Where, as is preferable, a remote human interior design consultant 300 or team of such consultants, provide support and their input to a web based system 100, the output thereof need not be provided immediately. In some scenarios the local consultant 250 who interacts directly with the customer 200 uses the system 100 as a resource for helping optimize the interior design and then advises the customer 200. In such a scenario, the system 100 may be web based, and supported by a server, accessible by the local consultant's 250 computer via the internet, b may also be software running on the computer system of the local consultant 250. Thus the system 100 provides a system for interaction and collaboration between a customer 200, a local consultant 250 and a design consultant 300. The system 100 thereby enables the consultants 250, 300 to interact with each other as well as with the customer 200 to collectively generate design suggestions 162 which best utilize the space in keeping with the needs of the customer 200.

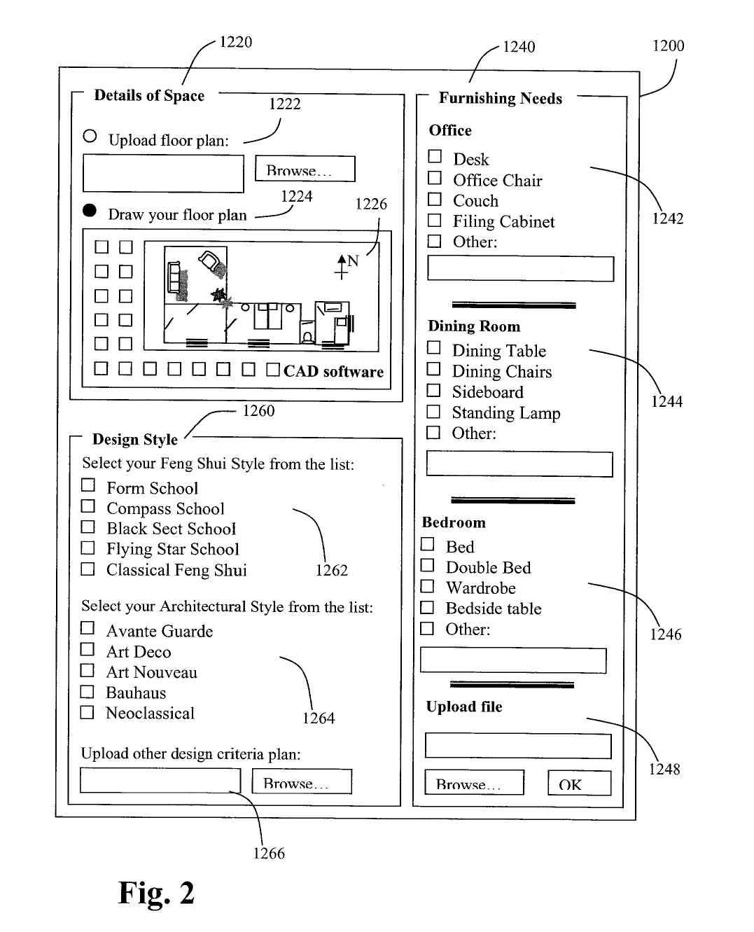

Reference is now made to FIG. 2 which shows a possible form 1200 to be used in the input interface 120 shown in FIG. 1. Three sections of the form 1200 are provided for inputting data related to the plan of the space 1220, furnishing requirements 1240 and design preferences of the client 1260. It is noted that in preferred embodiments, the input interface 120 is interactive. In such an interactive interface the sections 1220, 1240 and 1260 of the input form 1200 are customized to prompt the customer 200 for specific data useful to the local consultant 250 or the design consultant 300. Additional data may include additional floor plans, pictures taken from specific angles, other images and the like.

The section relating to the plan of the space 1220 comprises two fields. The first is for uploading a floor plan 1222. Such a plan can be in a variety of formats such as jpg, .pdf, .bmp, .doc, .ppt, .gif, .dxf, dwg and .vrml for example. Alternatively the user can opt to draw the plan directly into the form, perhaps using a basic CAD software module 1224 provided. Note that the orientation of North 1226 is generally a required field, since the orientation of a dwelling or office space is critical to understand the natural lighting and, various Feng Shui considerations regarding the space. The uploaded floor plan 1222 or the plan provided by the software module 1224 may represent a virtual space which is not physical in nature, such as the three dimensional setting for use in computer games, a website design, a film set design, the contextual setting for a work of fiction or a virtual reality environment for example.

The usage field 1240 provides an array of possible usages for the space, such as office 1242, dining room 1244 or bedroom 1246, for example. Each usage displays various examples of furniture which may be used in that space which can be selected by the user. In addition the user is provided with a furnishing preferences field 1248 for inputting details regarding the users furnishing needs. Although any file type could potentially be used, this file may be in any of a number of formats such as but not limited to .xls, .pdf, .csv, .doc, .ppt, .txt, .xml, .dbf, and .dif for example.

A design preference section 1260 is provided for the customer to select design preferences from a variety of such preconfigured design preferences. Some of these design preferences relate to the various Feng Shui schools 1262, others relate to other interior design styles and systems 1264. A user is additionally provided with a field for uploading a file containing additional design criteria which the user would like the system to use to provide design advice 1266. The file may be uploaded in any format, such as but not limited to .xls, .pdf, .csv, .doc, .ppt, .txt, .xml, .dbf, and .dif for example.

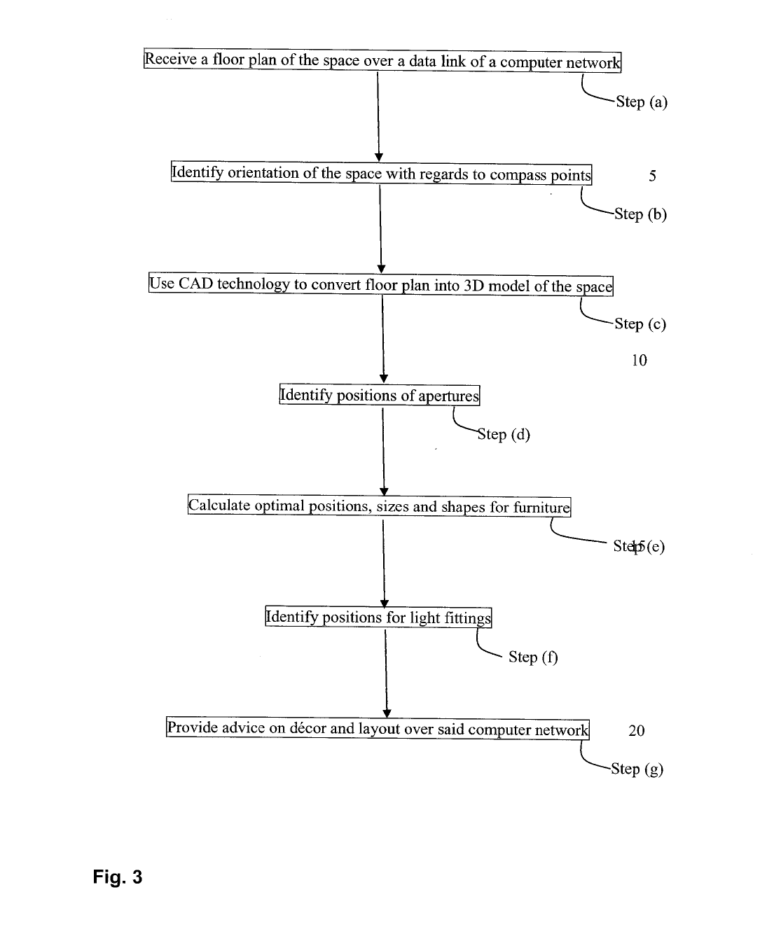

Referring now to FIG. 3, a method for providing a client with guidance concerning interior design of a space is shown. The method comprising the steps of:

(a) receiving a floor plan of the space over a data link of a computer network, typically an Internet; (b) identifying orientation of the space, such as by showing a North line, latitude-longitude gridlines or the compass points; (c) using CAD technology to convert the floor plan into a three dimensional model of the space; (d) identifying positions of apertures such as windows, doors and skylights; (e) calculating optimal positions, sizes and shapes for furniture. In an office, this would typically include desks, chairs, computers, bins, shredders, fax machines, copiers, hat stands, bookcases, etc. In the home, this may include positions of bathrooms, bedrooms, kitchens, living rooms and the furniture therein, such as chairs, beds, armchairs, tables, stove, bath, shower unit and the like; (f) identifying positions for light fittings and their type, wall lighting, ceiling lighting, chandeliers, spots, standing lamps, etc. (g) providing advice on décor and layout over the computer network.

Although the basic method is applicable with a wide range of design techniques such as Bauhaus, European, Art Nouveau, Deco, Avante Guarde, traditional UK, New world, etc. in preferred embodiments, the advice is in accordance with Feng Shui techniques which are being widely applied, even in the West.

The general method can be used for small office suites and apartments or for semidetached houses, detached houses, mansions, castles, office blocks, shopping centers, places of worship and other buildings. Indeed, the techniques are applicable to landscaping as well.

Thus a system and method for providing design consultancy to clients is provided, typically comprising an internet enabled computer having software for receiving a floor-plan, creating a virtual space from said floor-plan, querying client regarding furnishing needs and concerns; positioning furniture within virtual space and providing advice on furnishing and décor in accordance with design criteria, typically Feng Shui design criteria.

Software creating a virtual space in three dimensions in which furniture, décor such as wall papers, painting schemes, lighting and the like, non-supporting walls and the like can be rearranged is described. Such software is a powerful tool that could be utilized by real-estate agencies, interior designers, architects and others to present a three dimensional space to clients to see whether it fits the customer's needs.

Web enabled systems for end users to interact with remote consultants via a website are described, as are systems for local consultants to take advantage of powerful software to obtain design suggestions. Thus the scope of the present invention is defined by the appended claims and includes both combinations and sub combinations of the various features described hereinabove as well as variations and modifications thereof, which would occur to persons skilled in the art upon reading the foregoing description.

It will be appreciated that the technology described within could be used to apply Feng Shui and other design systems to virtual spaces by architects, town planners, designers of games, websites, animation, movies, and other applications, whether fantasy or realistic, and not merely for decorating or furnishing real spaces.

In the claims, the word “comprise”, and variations thereof such as “comprises”, “comprising” and the like indicate that the components listed are included, but not generally to the exclusion of other components.

We claim:

1. A system for providing design consultancy for a client said system comprising:
a. at least one database containing at least one set of design criteria;
b. at least one input interface for receiving data pertaining to:
i. the plan of the space for which design consultancy is required;
ii. the furnishing needs for said space; and
iii. the design preferences of the client;
c. a data processing unit for selecting at least one set of design criteria in accordance with the design preferences of the client and calculating positions of furniture within said space based upon said design criteria; and
d. at least one output interface for displaying design advice according to said positions calculated for said furniture.

2. The system according to claim 1, wherein at least one set of said design criteria comprises Feng Shui design criteria.

3. The system according to claim 1, wherein at least one set of said design criteria are associated with at least one school of architecture.

4. The system according to claim 1, wherein said input interface comprises a form having at least one field selected from the list comprising:
a. A field for uploading a preprepared floor plan of the space;
b. A field for preparing a plan of the space using CAD technology;
c. A field for identifying orientation of the space with regards to compass points;
d. A field for uploading a set of furnishing needs for said space;
e. A field for selecting a set of furnishing needs from a preprepared list;
f. A field for selecting at least one set of design criteria stored in the database to be used by the data processing unit;
g. A field for uploading a set of design criteria to be used by the data processing unit.

5. The system according to claim 4, wherein said form comprises an internet enabled web form remotely accessible via a website and displayable by an internet browser.

6. The system according to claim 4 wherein said form is part of a Graphical User Interface of stand alone software for displaying on a monitor of a computer system running the stand alone software.

7. The system according to claim 1 said output interface having a manual override comprising at least one field selected from the list of:
a. an editing field for altering configuration of furniture within the space as calculated by the data processing unit; and
b. an authorization field for authorizing design advice to be provided for a client.

8. The system according to claim 1 wherein said output interface comprises at least one of a list comprising a downloadable file, webpage and Graphical User Interface of stand alone software.

9. The system according to claim 1 wherein said space for which design consultancy is required is a virtual space.

10. A method of providing design consultancy for a client comprising at least some of the following steps:
a. saving at least one design criterion in a database;
b. providing at least one input interface for receiving data from a user;
c. obtaining data pertaining to the plan of a space for which design consultancy is required;
d. obtaining data pertaining to furnishing needs for said space;
e. obtaining data pertaining to design preferences of the client;
f. using said data processing unit to calculate suggested positions of furniture within said space based upon said design criteria and in accordance with the design preferences of the client; and
g. providing design advice based upon the suggested positions.

11. The method according to claim 10 wherein said at least one design criterion comprises a Feng Shui design criterion.

12. The method according to claim 10, wherein said at least one design criterion comprises design criteria associated with at least one school of architecture.

13. The method according to claim 10 further comprises using CAD technology to prepare a three dimensional plan of the space.

14. The method according to claim 10, further comprising providing at least one internet web form comprising fields for at least some of the following actions:
a. uploading a preprepared floor plan of the space;
b. preparing a plan of the space using CAD technology;
c. identifying orientation of the space with regards to compass points;
d. uploading a set of furnishing needs for the space;
e. selecting a set of furnishing needs from a preprepared list;
f. selecting at least one set of design criteria stored in the database to be used to calculate positions of furniture within said space;
g. uploading a set of design criteria to be used to calculate positions of furniture within said space.

15. The method according to claim 10 being facilitated by stand alone software and further comprising providing a Graphical User Interface of stand alone software for:
a. uploading a preprepared floor plan of the space;
b. preparing a plan of the space using CAD technology;
c. identifying orientation of the space with regards to compass points;
d. uploading a set of furnishing needs for the space;
e. selecting a set of furnishing needs from a preprepared list;
f. selecting at least one set of design criteria stored in the database to be used to calculate positions of furniture within said space;
g. uploading a set of design criteria to be used to calculate positions of furniture within said space.

16. The method according to claim 10 providing a manual override for:
a. altering a calculated configuration of furniture within the space; and
b. authorizing design advice to be provided for a client.
